(19) United States
(12) Patent Application Publication
(10) Pub. No.: US 2003/0046045 A1
(43) Pub. Date: Mar. 6, 2003

(54) Method and apparatus for analysing and modeling of analog systems

(76) Inventors: Lawrence Pileggi, Pittsburgh, PA (US); Peng Li, Pittsburgh, PA (US)

Correspondence Address: STEVEN B. PHILLIPS, MOORE & VAN ALLEN, SUITE 800, 2200 WEST MAIN STREET, DURHAM, NC, 27705, US

(21) Appl. No.: 10/100,402

(22) Filed: Mar. 18, 2002

Related U.S. Application Data
(60) Provisional application No. 60/317,740, filed on Sep. 6, 2001.

(51) Int. Cl. G06G 7/48

(52) U.S. Cl. 703/4

(57) ABSTRACT

Method and apparatus for analysis and modeling of analog systems. A system is partitioned for analysis by linearizing each non-linear element so that a large-signal operating point or some other weighted behavior of the non-linear element is captured in a linearized model. The linearized models are collapsed with linear elements so that the analog system is represented as a constant linear system with at least one, but possibly more independent energy sources. Once the system is partitioned in this way, an efficient steady-state non-linear analysis is performed to produce output responses at points of interest. Optionally, the steady-state analysis can be used to generate a macromodel of the analog system that can be used for system level analysis. A computer program product can be used to implement the invention, which can be applied to various types of analog systems, including analog circuits.

### CROSS-REFERENCE TO RELATED APPLICATION

This application claims priority from co-pending provisional patent application serial No. 60/317,740 filed Sep. 6, 2001 by the inventors hereof, the entire disclosure of which is incorporated herein by reference.

### BACKGROUND

As analog systems increase in complexity and models of high-frequency parasitics become more detailed, there is an ever-increasing demand for more efficient steady-state response analyses at both the circuit level and the behavioral level during the analog design process. Frequency domain methods provide a more efficient steady-state analysis than traditional time domain transient analyses, particularly for analog systems that are driven by wide-spread multi-tone excitations. However, modeling of nonlinearities, even subtle ones that represent the circuit response distortion, require harmonic balance methods which include nonlinearities via iterations between the time and frequency domain. The accuracy requirements and aliasing tolerances for harmonic balance type methods often require simulations at a large number of frequencies such that the problem size can render such methods ineffective.

Harmonic balance methods have typically employed Newton-based non-linear analysis methods for circuit-level steady state evaluation, but these methods are complex in terms of their computational requirements. Krylov-subspace iterative methods have been proposed more recently to solve large linear equations at each iteration to improve the overall efficiency. However, preconditioning is required to achieve good convergence and a complicated adaptive preconditioning scheme is needed where nonlinearities are severe.

In addition to circuit-level analog models there is a need for analog component macromodels that are efficient enough to be used to simulate the behavior of the entire analog system, and its interactions with digital circuits. Such behavioral level analyses are also based on steady state methods, and while the models are much simpler they are expected to capture the important system-level characteristics such as non-linear distortion and its impact on the overall system performance. In the past such analog circuit macromodels have been modeled via a non-linear frequency domain analysis based upon Volterra series. However, this approach is relatively inefficient, quite mathematically cumbersome, and limited to circuits with subtle nonlinearities. These limitations result from the fact that current sources for such a model depend on both the lower order circuit responses already computed and the nonlinearity coefficients, so that partial derivatives of the non-linear characteristics of different orders must be evaluated. The demand of nonlinearity coefficients requires the continuity of the device model and the existence of its high order derivatives, which are not always guaranteed, especially when measurement interpolation based device models is used. Also, as the order of non-linear analysis increases, derivatives of higher order circuit responses become more complex. Therefore, analyses via Volterra series models are usually limited to third order in practice. But the most restrictive aspect of the Volterra series based models and analyses is the limitation to circuits with weak nonlinearities.

### SUMMARY

Algorithms and an implementation are presented for both an efficient lower-level or circuit-level steady analysis method and a corresponding higher-level or system-level macromodel that includes the ability to represent the lower-level characteristics. The efficient circuit-level steady-state analysis approach is based upon modeling the analog circuit transistors and their non-linear behavior in terms of a combination of linear resistances, linear capacitances, linear inductances and linear controlled sources, along with corresponding frequency and/or time-domain non-linear independent current sources. The invention can also be used with other types of analog systems such as micro-electromechanical systems (MEMS). In this case, non-linear behavior is modeled in terms of linear forces, springs, masses, etc. The linear portion of the model, according to the invention, can be represented efficiently, for example, in terms of poles and zeros. The macromodel is based on a linear transfer function model, a representation of the nonlinearities based upon the aforementioned frequency and/or time-domain non-linear independent current sources, and an ideal system level description of the components.

According to one embodiment of the invention, an analog system with at least one linear and at least one non-linear element is partitioned into an initial linear subsystem and a non-linear subsystem including at least one non-linear element. Each non-linear element is modeled by creating a linearized model. The linearized model of the non-linear element is collapsed with the linear elements so that the analog system is characterized by a reduced circuit representation including a linear system with at least one, but possibly more independent current, voltage or other energy-producing sources. Once the system is partitioned in this way, the driving characteristics for each source are determined via an iterative procedure. Upon convergence these current and/or voltage sources, along with the linear circuit models, comprise the reduced circuit repsresentation of the analog system.

In one embodiment, a harmonic balance simulation is used in which non-linear equations are solved using successive chord iterations to generate functions for the energy-producing sources. In another embodiment, the energy-producing sources are generated, albeit less efficiently, by post-processing the time and/or frequency domain results from any analog circuit simulation tool into the form produced by the circuit-level analysis described herein. In either case, the resulting reduced circuit representation can be used to generate a compact, behavioral or block-level macromodel including distortion function blocks, a behavioral operator, and a linear transfer function block. The behavioral operator can be a summation unit (performing addition or subtraction) or a multiplication unit. In the case of a multiplication unit it can be disposed either before or after the behavioral operator.

In example embodiments of the invention, computer program code or software in the form of a computer program product is used to implement many aspects of the invention. The software can be stored on a medium. The medium can be magnetic, such as a diskette, tape, or fixed disk, or optical, such as a CD-ROM or DVD-ROM. The software can also be stored in a semiconductor device. Additionally, the software can be supplied via the Internet or some other type of network. A workstation or computer system typically runs the software. This computer system, also called a “instruction execution system,” in combination with computer program instructions form the means to carry out the invention. A macromodel that is created according to the invention can be defined by descriptions contained in a data structure which is then encoded in machine readable memory.

### BRIEF DESCRIPTION OF THE DRAWINGS

FIG. 1 shows a flowcharts which illustrate the overall method according to example embodiments of the invention. FIG. 1 is divided into FIGS. 1A and 1B. FIG. 1A illustrates the method for weakly non-linear analog systems, and FIG. 1B illustrates the corresponding method for strongly non-linear analog systems.

FIG. 2 shows a process flow for the overall method for efficient linear-centric circuit-level analysis and creation of a corresponding system-level marcomodel for both weakly and strongly non-linear analog systems.

FIG. 3 illustrates a weakly non-linear example circuit to which the invention can be applied and the partitioning of that circuit according to the invention. FIG. 3 shows the progression of the partitioning process through successive FIGS. 3A-3D.

FIG. 4 illustrates the small-signal model and a large signal model of a given transistor according to the invention in FIGS. 4A and 4B, respectively.

FIG. 5 illustrates how a MOSFET is partitioned according to the invention in steps shown as FIGS. 5A and 5B.

FIG. 6 shows a flowchart illustrating a harmonic balance simulation that can be used with the present invention.

FIG. 7 illustrates the use of chord analysis according to the invention. FIG. 7 is divided into FIGS. 7A and 7B for convenience.

FIG. 8 illustrates the partitioning required with a multi-circuit simulation that can be used with the present invention, in steps shown as FIGS. 8A and 8B.

FIG. 9 illustrates an example of source characteristics that are derived for a partitioned circuit. FIG. 9 shows multiple plots illustrated as FIGS. 9A through 9G.

FIG. 10 illustrates strongly non-linear example circuit to which the invention can be applied.

FIG. 11 illustrates an example of source characteristics that are derived from a circuit like that shown in FIG. 10. FIG. 11 shows multiple plots illustrated as FIGS. 11A through 11G.

FIG. 12 illustrates some aspects of determining and applying equivalent input sources as needed to create a compact behavioral level macromodel according to some embodiments of the invention.

FIG. 13 illustrates a detailed compact behavioral-level macromodel for an additive circuit.

FIG. 14 illustrates a compact behavioral-level macormodel for a multiplicative circuit.

FIG. 15 illustrates another compact behavioral-level macormodel for a multiplicative circuit.

FIG. 16 shows the equivalence between a circuit and a MEMS, illustrated as corresponding FIGS. 16A and 16B.

FIG. 17 is a block diagram of a instruction execution system that executes computer program code instructions to carry out the invention in some embodiments.

### DETAILED DESCRIPTION OF ONE OR MORE EMBODIMENTS

In order to fully enable the invention describe herein, example embodiments are presented mostly in the context of analog circuit analysis. Additionally, some discussion of MEMS is presented. It should be understood, however, that the invention can work with other types of analog systems, and can even work with systems exhibiting extreme nonlinearities. The term “system” herein is used to emphasize the generically applicable nature of the invention in that a system can be a circuit, a MEMS device, or another apparatus that operates according to analog principles. The term “system” does not necessarily imply a collection of circuits. In the case of circuits, the analog analysis and macromodeling methodology of the invention conceptually begins with separation of non-linear and linear circuit elements. Eventually, the overall circuit is modeled as a linear, time-invariant circuit with controlled sources, plus corresponding, independent current and/or voltage sources for analog circuit analysis. Based upon this model, a linear-centric stimulation methodology is used whereby the analysis iterates on the non-linear behavior in time and/or frequency domain while representing the nonlinearities via these non-changing linearized models. In some embodiments, the iteration is accomplished through the successive chord algorithm for solving non-linear systems of equations. Using this iteration scheme, the linear time-invariant portion of the circuit is unchanged, and the independent current and/or voltage sources become time and/or frequency dependent—depending upon the analysis of interest.

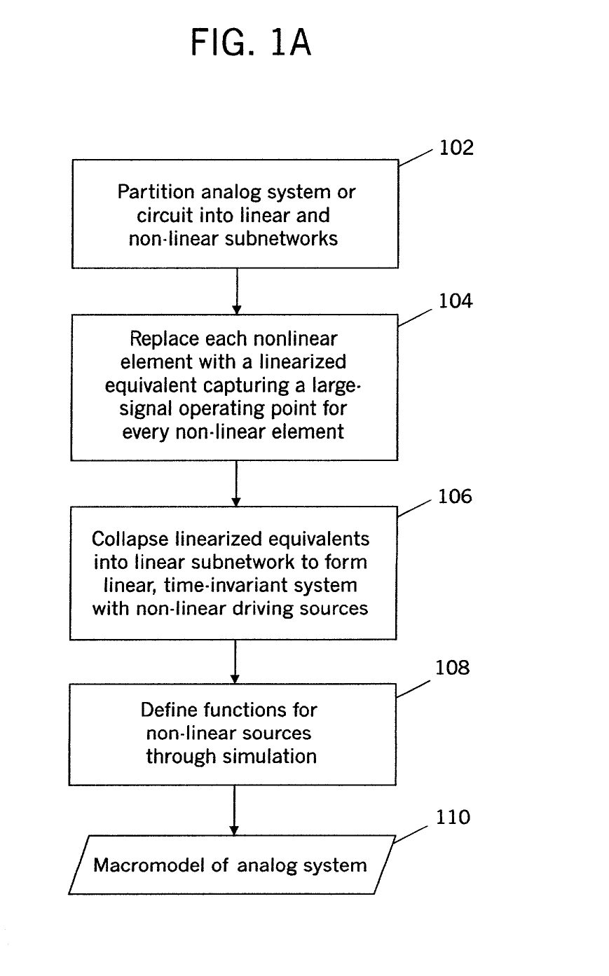

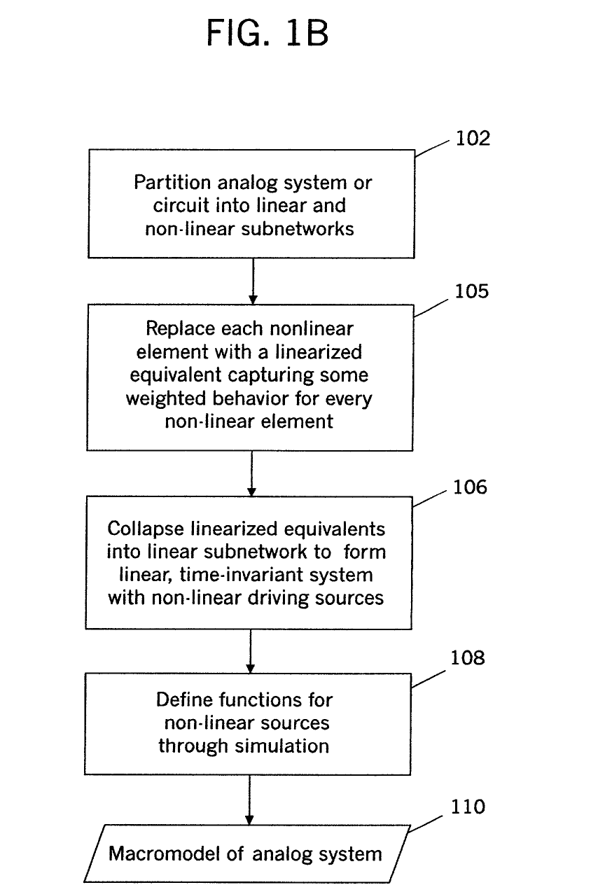

FIG. 1 is a flowchart illustrating the overall method according to one embodiment of the invention, for analog circuit analysis of weakly non-linear systems. FIG. 1A illustrates the process for weakly non-linear systems. At step 102 the overall system is partitioned into linear and non-linear subnetworks. At step 104, each non-linear element is replaced with a linearized equivalent circuit that captures a large-signal operating point or small-signal equivalent circuit model. At step 106, the linearized equivalents are collapsed into the linear subnetwork to form a linear, time-invariant system with independent, non-linear driving sources. At step 108, characteristic functions for the non-linear, driving sources are defined through simulation and applied to the time-invariant, linear system to produce simulation results, and/or optionally to generate a macromodel as shown at 110.

FIG. 1B illustrates the same process as in FIG. 1A, but in this case for strongly non-linear systems. In the case of FIG. 1B, all steps are the same except for step 104, which in the case of FIG. 1B is replaced with step 105. In this case, each non-linear element is replaced with a linearized equivalent capturing some weighted behavior, not necessarily a large-signal operating model.

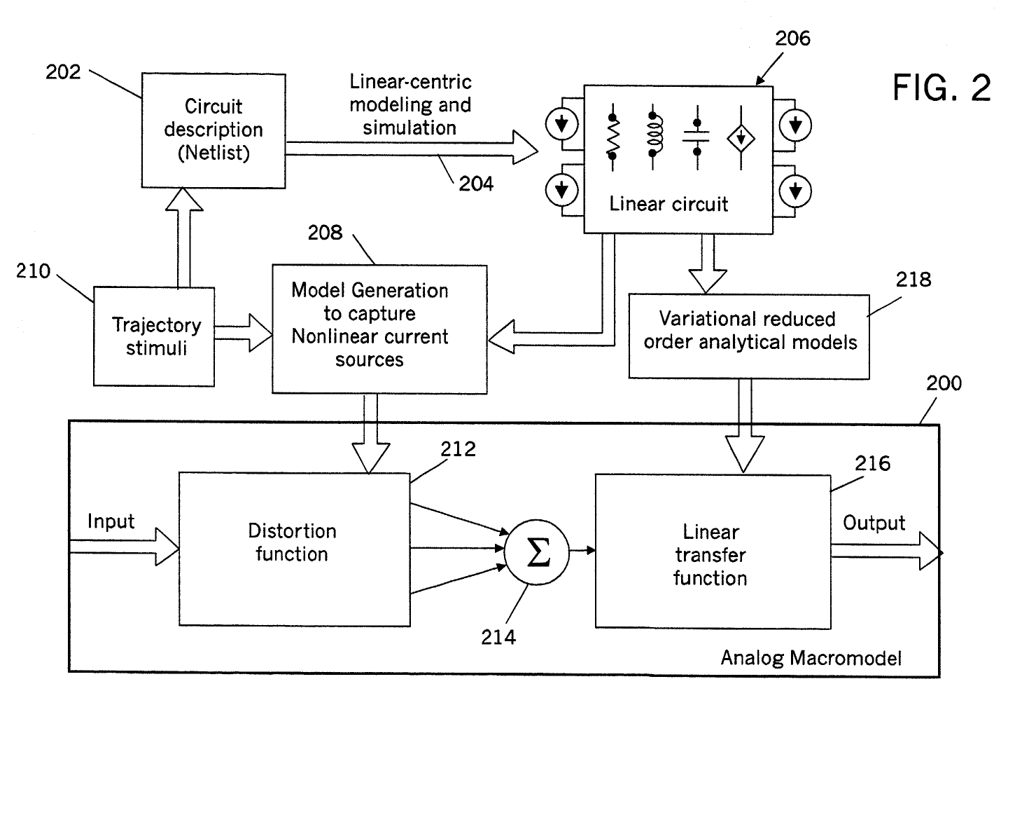

FIG. 2 illustrates the step of creating or generating an analog macromodel, 200, in further detail. This example assumes the analog system is a circuit, but the process for other analog systems is essentially the same. The process starts with the circuit description at 202 and the circuit is linear-centrically analyzed and partitioned at 204 as shown in the first portion of FIGS. 1A and 1B and discussed in detail below. In a computerized system, this circuit description might be a netlist. The linearized, reduced representation, 206, including a linear circuit and current sources, is then used to create the macromodel. Since the resulting reduced circuit representation consists of linear circuit elements and certain linearizations (chords) of non-linear elements, a linear-centric analog simulation and model generation method, 208, can be used to analyze the circuit for a chosen set of input stimuli.

Upon the completion of each simulation run, chord current sources of all circuit nonlinearities are made available along with circuit responses at output nodes. The circuit under the excitation of a particular input stimulus can now be represented by applying not only external inputs but also independently varying time/frequency domain chord current or voltage sources to the linearized circuit. In a linear-centric macromodel, the non-linear system behavior is captured by chord current sources and the model of the chord current source of a non-linear element is generated as a function of input stimulus. It should be noted that each independent source shown in the illustrated examples can be represented in either the time domain or the frequency domain, or can be a combination of sources.

For each chord current source, an equivalent input source can be found and applied at the external input port to generate the same circuit response. The value of the equivalent input source can be simply computed as the circuit response due the corresponding chord current source divided by the transfer function from the input port to the output node. Since one linear-centric simulation generates chord currents only for that specific input stimuli, we must analyze the circuit over a trajectory or set of input stimuli, 210. Each of these equivalent input sources are in general a function of the external input, as well as a function of the circuit non-linear characteristics. These equivalent sources can be combined with the original circuit input at the input port to result an overall equivalent input source. It is important to realize the overall equivalent input source captures the circuit non-linear behavior since it is a sum of original circuit input and equivalent input sources for all the chord current sources. Again, generally, embodiments of the invention can be created wherein independent sources can be voltage or current sources, and can be represented in the time domain or the frequency domain.

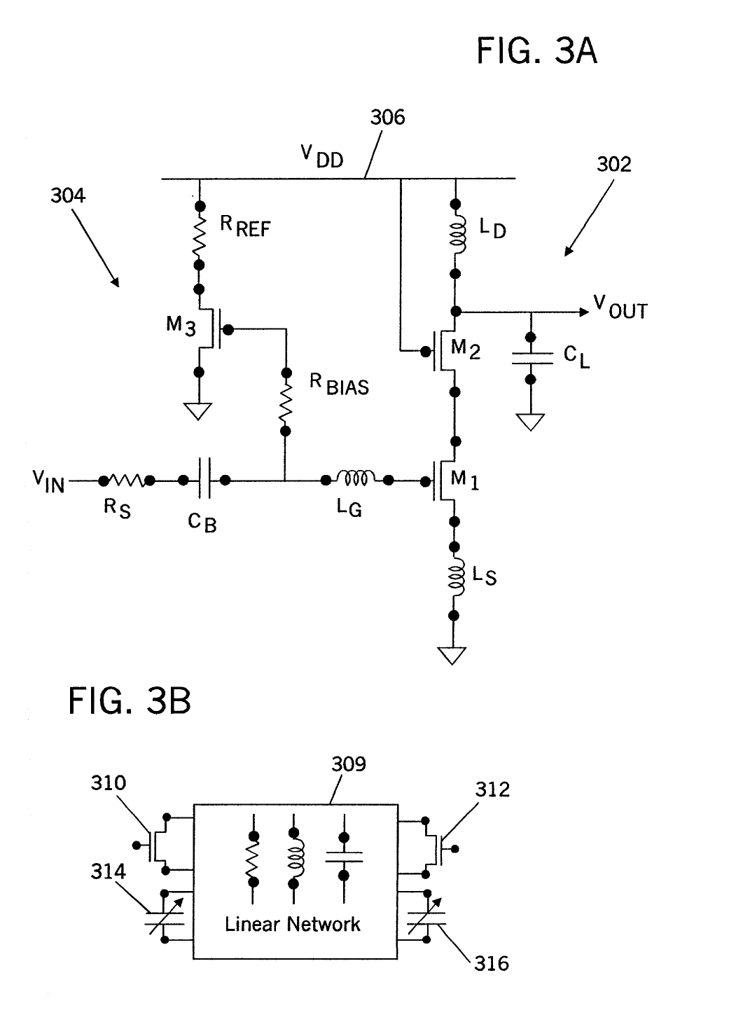

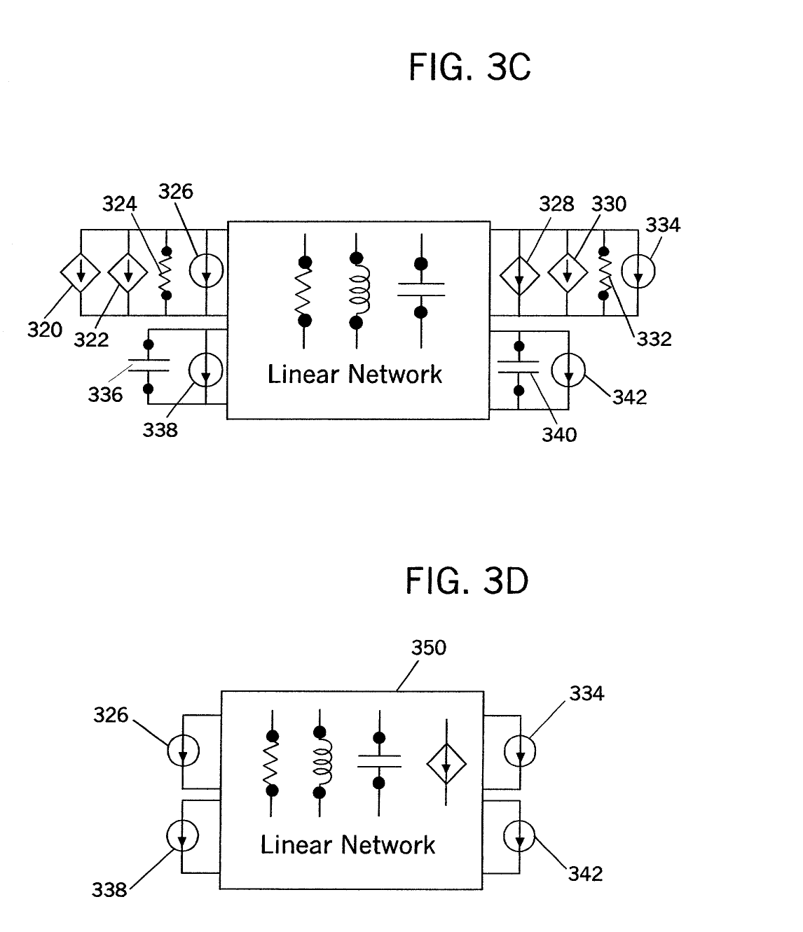

In the complete process discussed above, a compact block or behavioral block macromodel results, and this is the type shown in FIG. 2 as an example. This macromodel, 200, includes distortion function blocks 212, behavior operator 214, and a linear transfer function block, 216, as well as at least one input and an output. The linear transfer function block can be reduced using model order reduction techniques to increase the model compactness, which may be important if mathematical descriptions of the model are stored in a computer system. The resulting variational reduced order analytical models, 218, can also be incorporated to account for effects of manufacturing variations as they impact the linear transfer function model and the distortion function block model. This macromodel can be ultimately derived from the reduced circuit representation shown in FIG. 3D, as discussed below, together with the appropriate source characteristics, or it can be generated using data from another simulation or characterization procedure.

FIG. 3 illustrates the partitioning and related steps of FIG. 1 with reference to an example circuit, a low-noise amplifier (LNA). FIG. 3A is an actual schematic diagram of the circuit, with input V_{IN} and output V_{OUT}. Transistors M₁ and M₂ are non-linear elements forming output circuit 302 with drain inductance L_{D} and source inductance L_{S}, as well as load capacitance C_{L}. Transistor M3 forms bias circuit 304 with resistances R_{REF} and R_{BIAS}. Power supply voltage V_{DD} is provided from rail 306. Other linear elements in the circuit include resistance R_{S}, capacitance C_{B} and gate inductance L_{G}.

The circuit of FIG. 3A is conceptually partitioned as shown in FIG. 3B. Linear subnetwork 309 includes resistances, inductances, and capacitances. A non-linear subnetwork is made up of transistors such as 310 and 312 as well as variable capacitances 314 and 316 to represent some of the capacitances between terminals. The non-linear subnetwork can include additional transistors and capacitors—this is an illustrative example and not all of the transistors and capacitors that would be present for a circuit like that of FIG. 3A are shown.

Each non-linear element in the non-linear subnetwork of FIG. 3B is replaced by a linearized equivalent circuit, or linearized representation of the element, as shown in FIG. 3C. Controlled current sources have a diamond outline, and independent current sources have a circular outline. Transistor 310 is replaced by an equivalent circuit consisting of controlled current sources 320 and 320, resistance 324, and independent current source 326. Transistor 312 is replaced by an equivalent circuit consisting of controlled current sources 328 and 330, resistance 332, and independent current source 334. Finally, variable capacitance 314 is replaced by fixed capacitor 336 and independent current source 338, and variable capacitance 316 is replaced by fixed capacitor 340 and independent current source 342. The linearized equivalents are then collapsed into the linear subnetwork as shown in FIG. 3D. The linear elements in the equivalent circuits become part of the linear subnetwork resulting in subnetwork 350, which includes resistances, inductances, capacitances, and controlled sources. The remaining corresponding independent current sources, 326, 334, 338, and 342 drive the linear, constant system. The reduced circuit representation that is directly derived from the linear-centric analysis shown includes the linear network of FIG. 3D and the current sources, each having the appropriate time/frequency domain varying values.

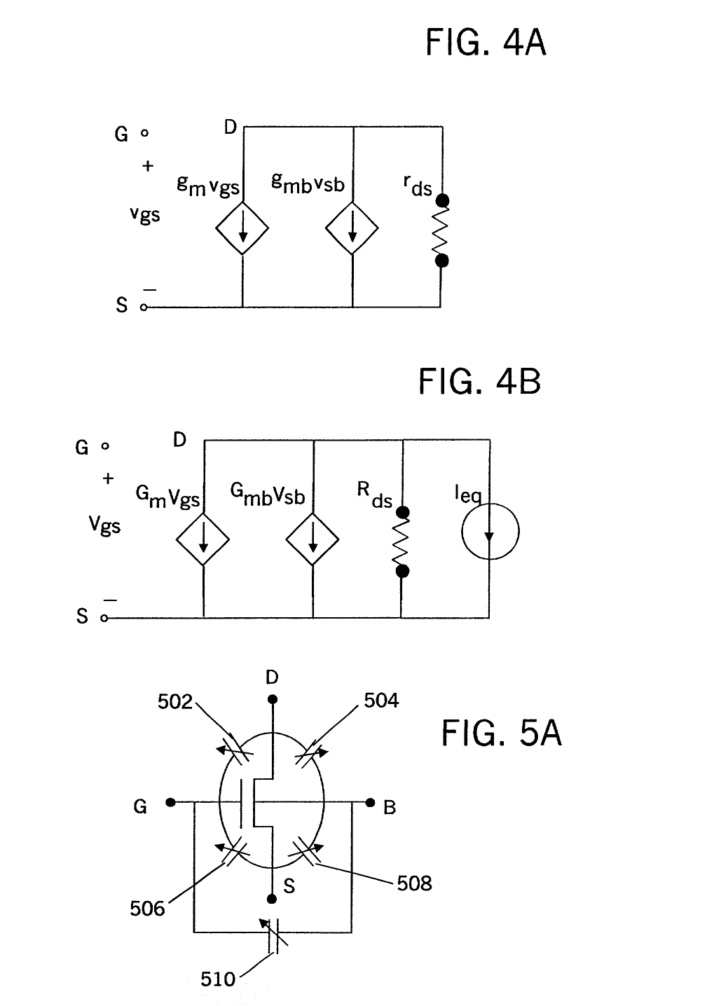

FIG. 4 contrasts the small-signal model of a MOSFET with the large-signal model of a MOSFET in the context of the invention. The small-signal model is shown in FIG. 4A and the large-signal model is shown in FIG. 4B. Unlike a small-signal ac analysis model, the linearized equivalent transistor model employed with the invention will capture an actual large-signal operating point for non-linear elements, such as transistors. In the linearized large-signal model shown in FIG. 4B, time and frequency dependent current source I_{eq} is included to capture large-signal behavior and allows the device behavior to be modeled based upon a best-chosen linearized model. These linearized models are constant in that the resistances, capacitances, inductances and controlled sources are constant for the entire analysis of the non-linear behavior.

In both FIGS. 4A and 4B, the voltage between gate G and source S of the transistors, v_{sg} and V_{gs}, affect the values for the controlled current sources, gₘv_{gs}, g_{mb}v_{sb}, GₘV_{gs} and G_{mb}V_{sb}, which are disposed between the drain D and source S. In FIG. 4B, values of Gₘ, G_{mb}, R_{ds} can be, but are not necessarily, equal to their small-signal counterparts gₘ, g_{mb}, r_{ds} as shown in FIG. 4A. Linearized models according to example embodiments of the invention include dissipative elements, such as resistors and transimpedance elements; energy storage elements, such as capacitors and inductors; and independent current or voltage sources. For comparison purposes, the proposed model for the LNA in FIG. 3A could be represented by a linearized large-signal model that is equivalent to a small-signal model but includes the additional independent source. The independent source captures the large-signal behavior and the notion of an operating point for a non-linear model that is missing from a small-signal representation. Importantly, the methodology of the invention is not limited to, nor does it rely upon the availability of the small signal model. In many circumstances, however, this is the ideal model for a proposed analyses, for example, a distortion analysis, whereby the deviation from the ideal behavior represented by a linear small-signal model is being measured.

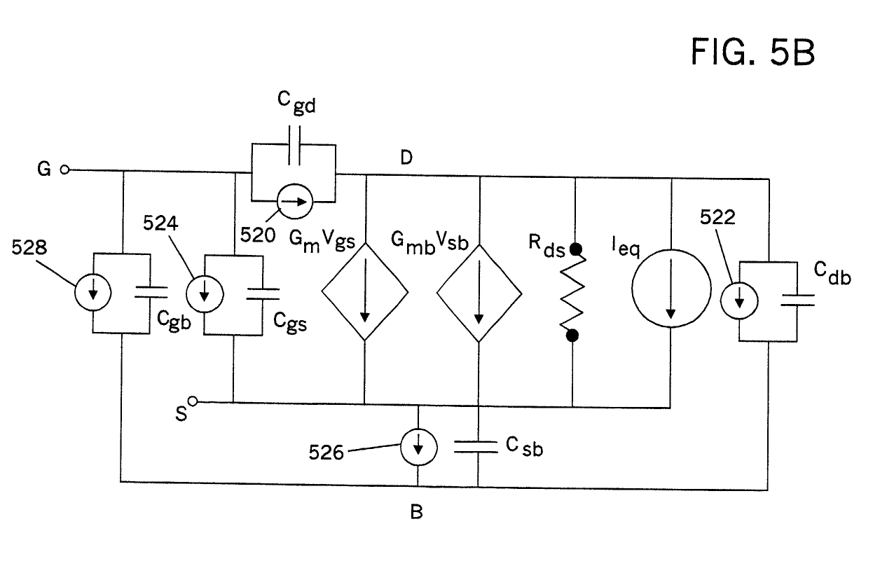

FIG. 5 presents a more accurate linearized large-signal model of a MOSFET, which can be used with the invention. FIG. 5A shows a MOSFET having drain D, source S, gate G, and body terminal B. In reality, capacitances exist between all the terminals, and these capacitances vary depending on the operating point of the device. These are shown in FIG. 5A as variable capacitances 502, 504, 506, 508, and 510. In FIG. 5B these capacitances can be linearized as fixed capacitors C_{gd}, C_{db}, C_{gs}, C_{sb}, and C_{gb}, respectively, with corresponding independent current sources 520, 522, 524, 526, and 528, respectively. Other elements are as described with respect to FIG. 4.

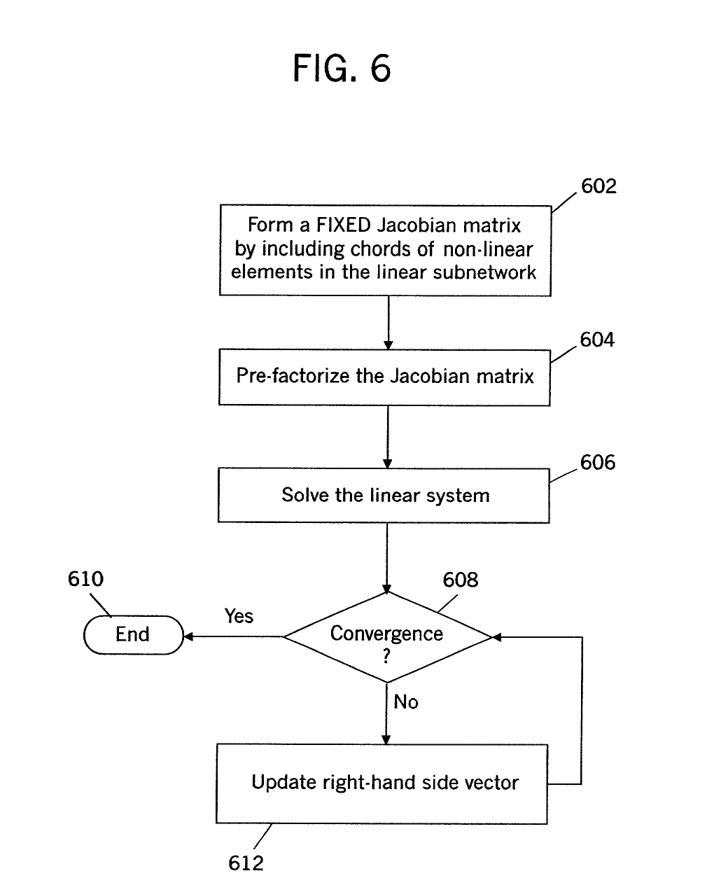

With the above large-signal models in mind, a harmonic balance (HB) method of simulating system behavior can be applied to determine functions and/or characteristics of independent source to create a macromodel according to one embodiment of the invention. In this harmonic balance method, non-linear, HB equations are iteratively solved using a chord algorithm. FIG. 6 illustrates this method in flowchart form. The process begins with the formation of a Jacobian matrix at step 602. The matrix is pre-factorized at step 604. An initial solution is tried at step 606. At this point, the solution will normally be found not to converge at step 608, and the right-hand side of the matrix will be updated iteratively through a successive chord algorithm at step 612. When convergence is reached at step 608, the process ends with the solution to the functions of the independent sources at 610.

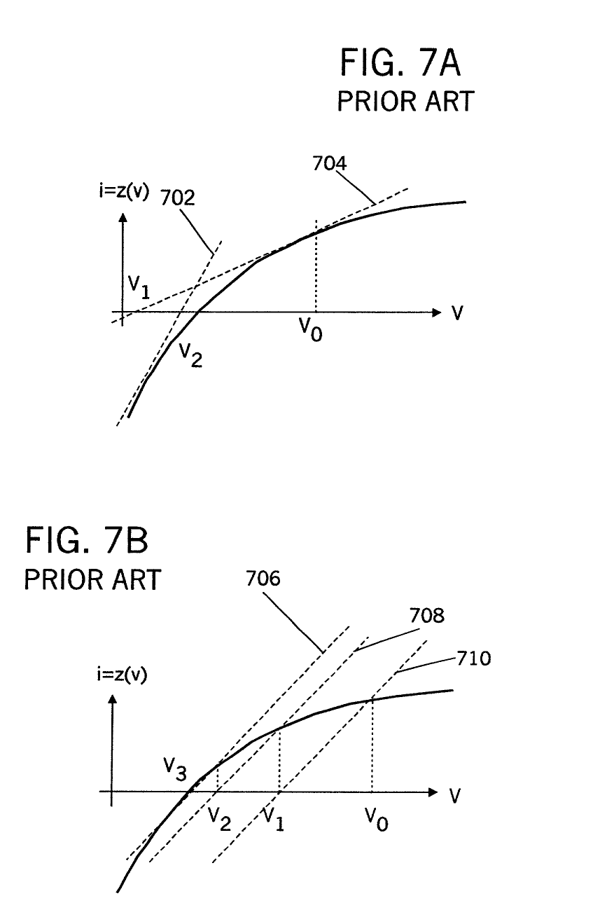

FIG. 7 illustrates the chord analysis that can be used with the present invention. FIG. 7A illustrates a Newton-Raphson method. FIG. 7B illustrates the chord method by contrast. Note in FIG. 7A, linearizations, 702 at voltage v₂, and 704, between voltage v₁ and v₀ are different, since with this method, a changing linearization is computed at each iteration. In this case, the corresponding linear system is solved for each new solution updated. In contrast, with chords as shown in FIG. 7B, a constant linearization is used for all iterations. Note that linearizations 706, 708, and 710 at v₃, v₂, and v₁ are the same. With the chord method, the system solution is obtained by iterating a constant linear system, result in less computation per iteration.

It should be noted that with the above HB simulation technique as used with the invention, the stamping of MOSFETs is greatly simplified. With the well-known Newton-Ralpson analysis, the characterization (stamping) of a MOSFET in a simulation requires that the derivatives of the drain-source currents be determined multiple times and fast Fourier transforms (FFT's) be taken of the derivatives of the currents in order to update the Jacobian matrix. With the HB technique employed in the manner of the invention, no derivatives are needed to add contributions to the right-hand side of the matrix with each iteration.

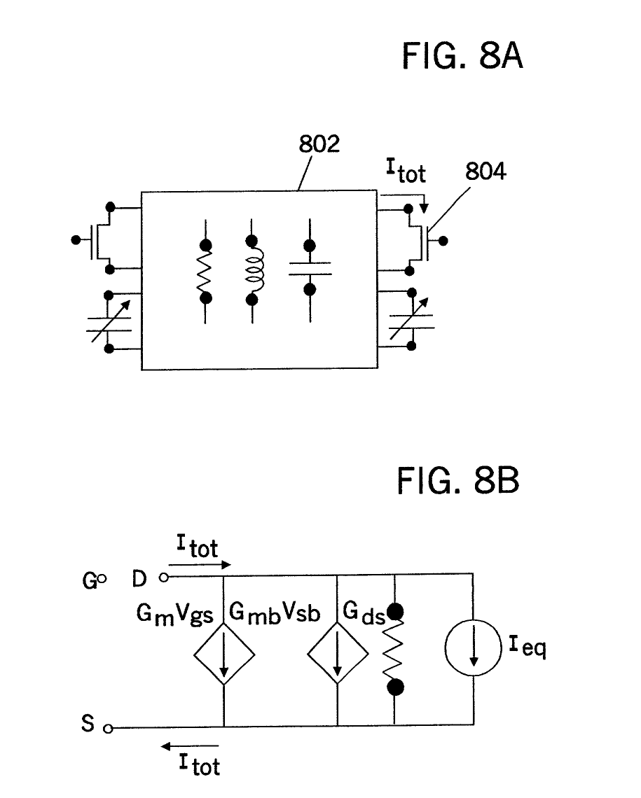

It should also be noted, that with respect to circuit analysis, the values of non-linear current sources can be extracted or “reverse-engineered” from traditional simulation results to produce an equivalent linear-centric macromodel representation. In this way, the invention can be implemented without the HB simulation technique discussed above. If the non-linear circuit is simulated using the linear-centric simulation methodology and the same linearized circuit is used for both simulation and macromodeling, then a non-linear current source for each nonlinearity is generated upon completion of the simulation. For a more traditional simulation, a post-simulation processing step could be used to compute these non-linear current sources. FIG. 8 illustrates this simulation technique. As shown in FIG. 8A, the linear subnetwork of a partitioned, non-linear circuit is represented by multiport 802, in which non-linear elements are connected with the linear network through ports (input ports are not shown for clarity). Once the simulation is completed, the current flowing out each port can be determined by evaluating non-linear device currents using terminal voltages at different time points. Transistor 804 is fed by current Iₜₒₜ flowing out of a port. Other elements are as shown in FIG. 3D. By subtracting the current component that flows through the linearization of a non-linear element from the total port current, one can obtain the value of the non-linear current source that is equivalent to that generated via the linear-centric methodology. Note, in the corresponding large-signal model shown in FIG. 8B, the port current Iₜₒₜ consists of currents I_{eq}, GₘV_{gs}, G_{mb}V_{sb}, and any current through resistance G_{ds}.

Values of a non-linear current source in the time domain can be also transformed to frequency domain and expressed in terms of Fourier coefficients. By applying these computed non-linear current sources together with circuit inputs to the linearized circuit that includes linearizations of all non-linear elements, each port current precisely represents the nonlinearities for that simulation. This is guaranteed by the substitution theorem, namely that the response of the linearized circuit when excited by the non-linear current sources, is identical to the original non-linear circuit.

Notice that in general, non-linear current sources would be a function of input stimuli. When a regression model of the dependency of non-linear current sources on circuit inputs is desired, input space of interest might be sampled according to frequencies and magnitudes. Then, circuit simulation is performed at each sampled point to generate values of non-linear current sources. Finally, regression or interpolation techniques can be used to build a regression model that can be used for characterizing the nonlinearities in a macromodel for a system level simulation, one example of which is a model based on the time and/or frequency domain independent source functions of the distortion function block shown in FIG. 2. This linear-centric view of the circuit can greatly simplify this regression modeling process.

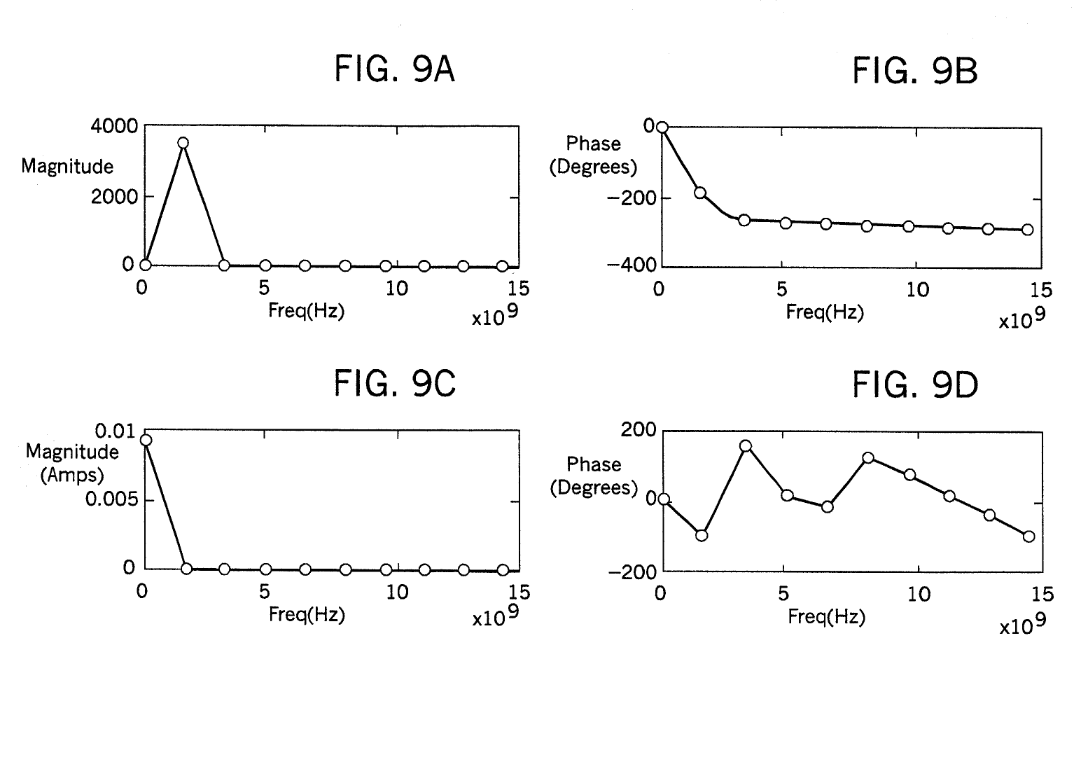

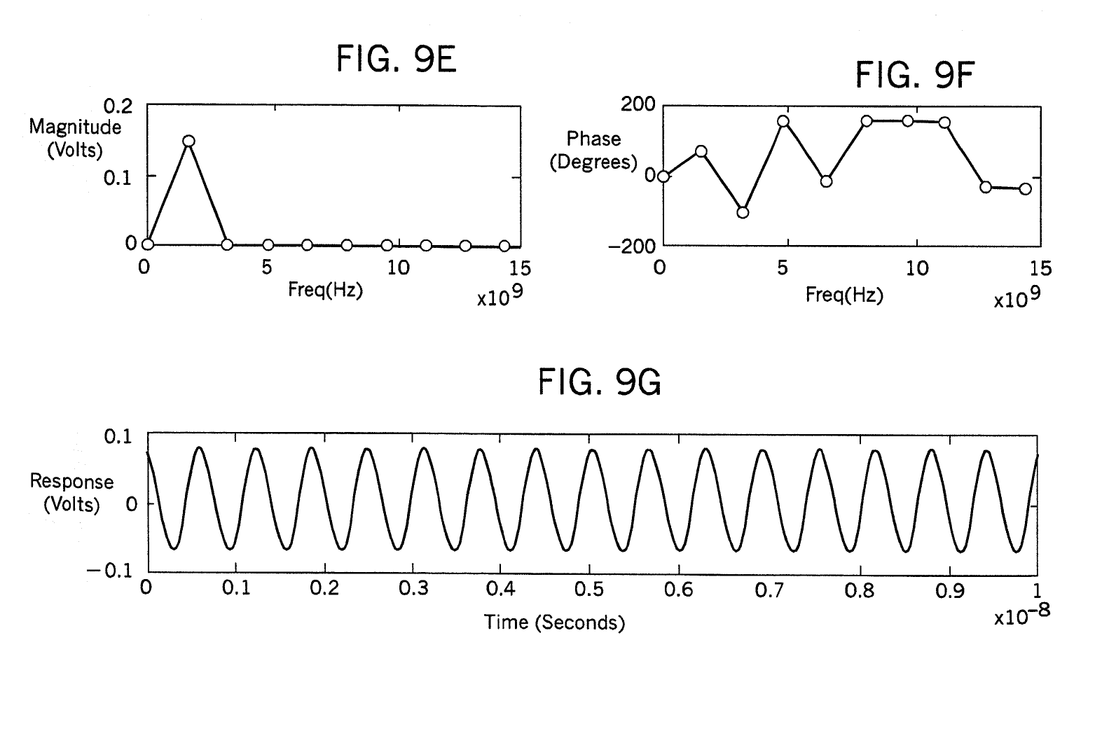

FIG. 9 illustrates some of the macromodeling results obtained using an embodiment of the invention with the HB simulation technique providing functions for non-linear sources for the LNA shown in FIG. 3A. Plots in FIGS. 9A and 9B show the magnitude and phase of the transfer function for M₁ in the frequency domain, respectively. Plots in FIGS. 9C and 9D show the magnitude and phase for the current source spectra for M₁, respectively. Plots in FIGS. 9E and 9F show the magnitude and phase for the voltage response of M₁ in the frequency domain, respectively. Finally, the plot in FIG. 9G is the time domain response of M₁ in volts.

The transfer function from the current source corresponding to M₁ to the output node as shown in FIG. 9 was calculated based on the overall linearized circuit. Multiplying this transfer function by the spectra of the current source yields partial response at the output node due to the current source. Finally, examination of the spectra of the partial response would disclose the non-linear distortion contributed by M₁ at individual frequencies. This approach not only provides various non-linear distortions measures such as harmonic distortions, intermodulations and intercept points at the node of interest, but also traces the presence of non-linear distortion at a node back to origins of distortions, i.e. non-linear devices in the circuits. Thereby, a design effort can be devoted to devices that generate most of distortions to improve the overall circuit linearity.

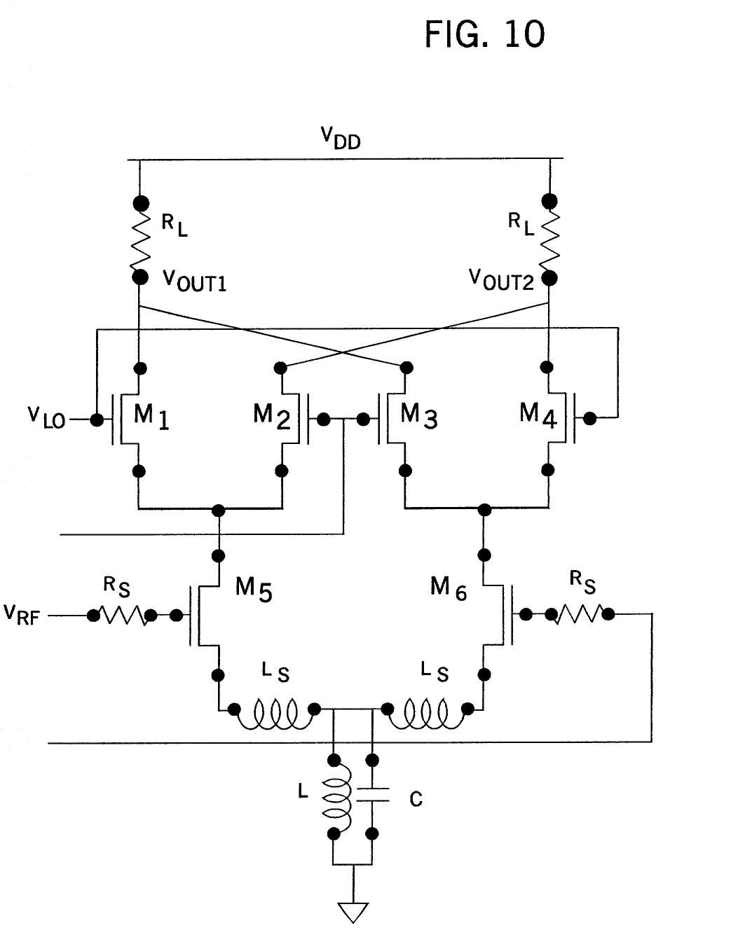

The same type of analysis and modeling as performed on the LNA and shown in FIG. 9 was performed for the double-balanced mixer circuit of FIG. 10. The circuit consists of transistors M₁, M₂, M₃, M₄, M₅ and M₆. The lower frequency signal is input at V_{LO} and the higher frequency signal is input at V_{RF}. The two output frequency signals are output at terminals V_{OUT1} and V_{OUT2}, in part based on current through load resistors R_{L}, which are connected to the V_{DD} rail. The high frequency signal gates transistors M₅ and M₆ through resistors R_{S}, which are in turn connected to ground through inductances L_{S} and an LC circuit consisting of inductance L in parallel with capacitance C.

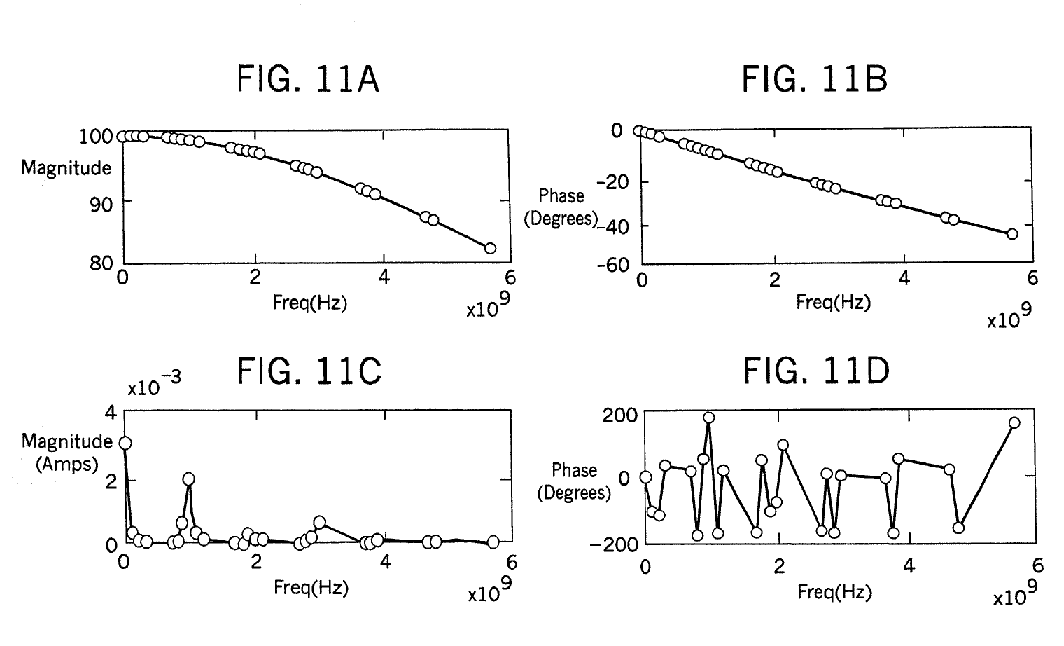

As shown in FIG. 11, using the HB analysis, non-linear source embodiment, this linear-centric macromodeling techniques can facilitate distortion analysis of strongly non-linear analog circuits like the mixer of FIG. 10. The plots of FIG. 11 are for transistor M₂. The plots in FIGS. 11A, 11B, 11C, 11D, 11E, 11F, and 11G show the same functions as those discussed with respect to FIG. 9. In the double-balanced mixer of FIG. 10, MOSFET M₂ works as a switcher. The analysis of M₂ can present both the basic non-linear properties on which the circuit operates and unwanted distortion measures.

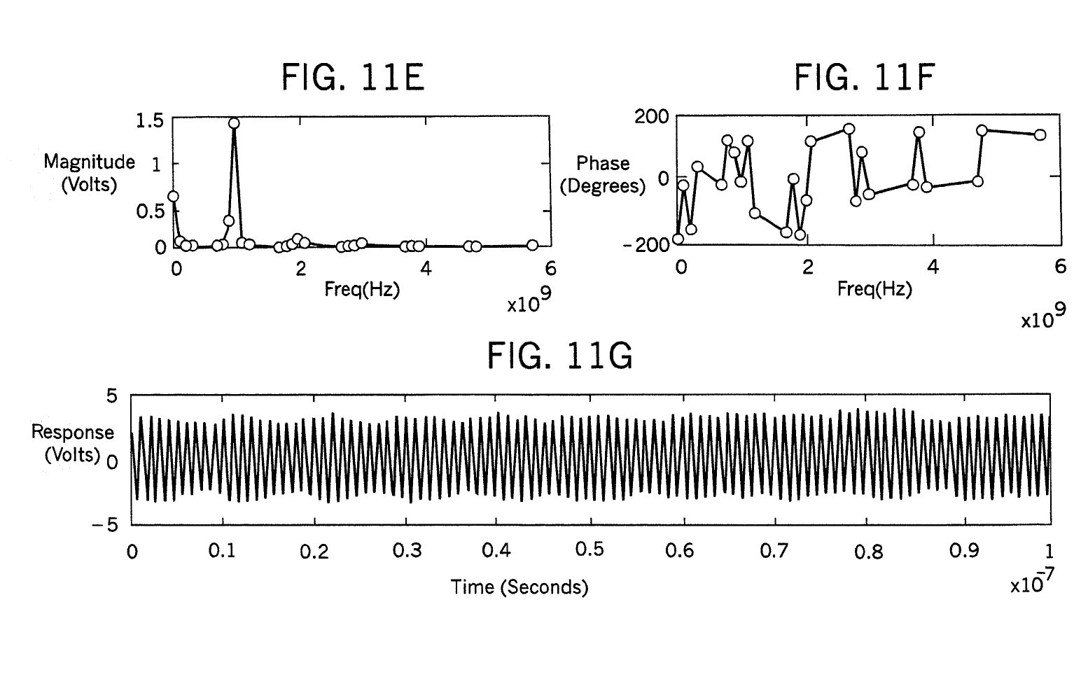

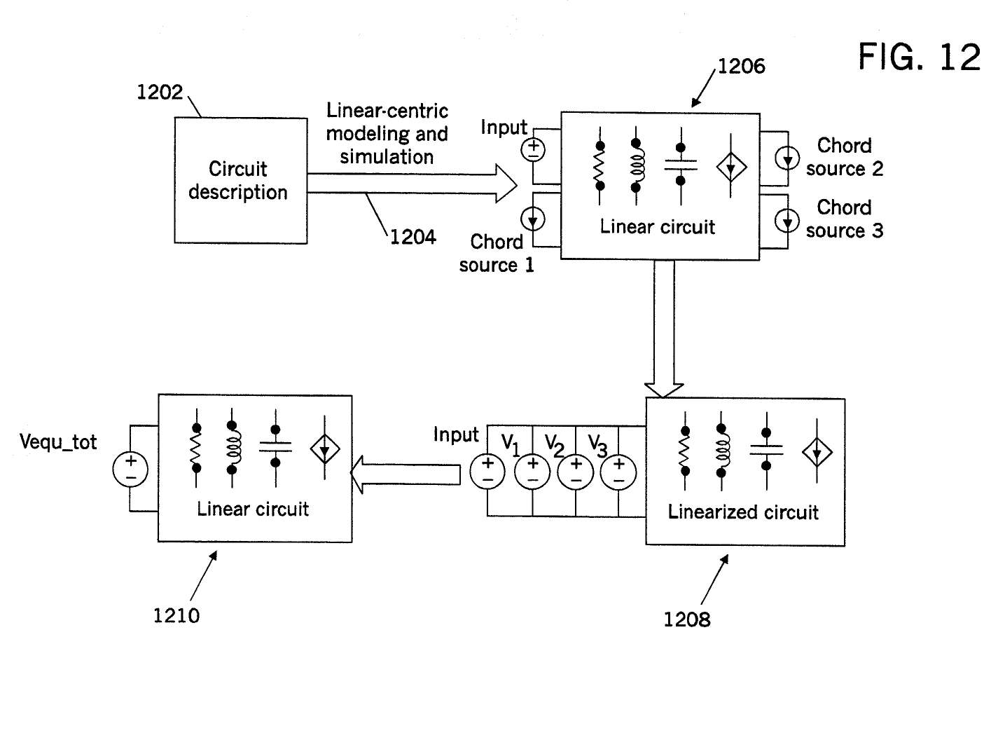

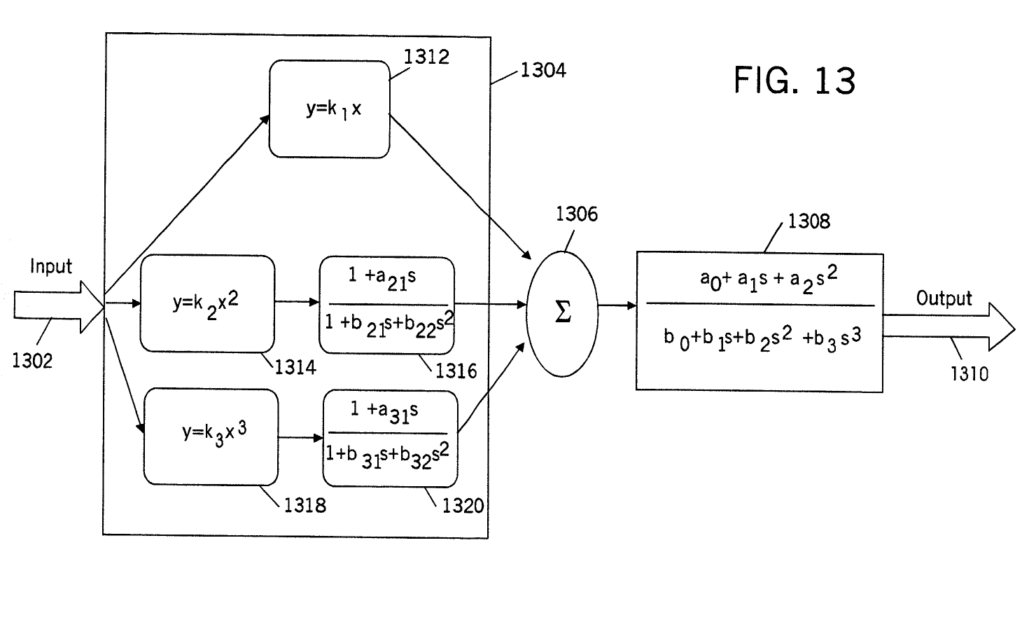

FIGS. 12 and 13 illustrate further detail of creating a compact block or compact behavioral macromodel, in part using traditional simulation methods, for the amplifier circuit. Again, a circuit description 1202 is the starting point, and this is partitioned through linear centric modeling. The linear-centric modeling and simulation, 1204, results in a linear circuit model with an input voltage source and output chord current sources, as shown at 1206. For the chord current sources, equivalent input voltage sources, v₁, v₂, and v₃ can be determined as shown at 1208. All of the equivalent input sources are combined to form an equivalent, total input source, v_{equ-tot} at 1210.

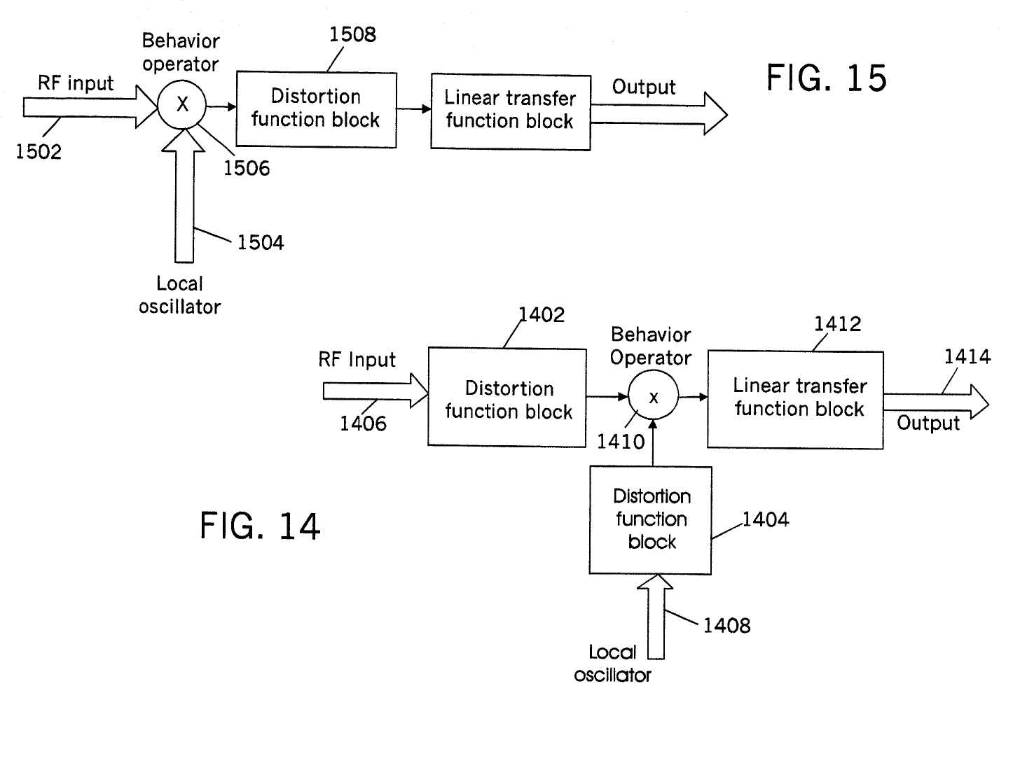

FIG. 13 is a detailed block diagram of a compact, behavioral block macromodel created as described above. This particular macromodel is for an additive circuit. Multiplicative circuits, such as mixers, are discussed with respect to FIGS. 14 and 15. In FIG. 13, input 1302 enters distortion function block (DFB) 1304. The distortion function block is introduced for a circuit input to model the non-linear behavior due to any expected instance of input excitation. Behavior operator 1306 describes the fundamental fashion in which the circuit operates, and it is a characterization of the system functionality. In general, a behavior operator takes one of two forms, an ideal summation unit or an ideal multiplication unit for “additive” and “multiplicative” circuit behaviors respectively. FIG. 13 illustrates the additive case. Linear transfer function block (LTFB) 1308 represents the linear portion of the model, and is connected to output 1310. The example transfer function shown in the LTFB in FIG. 13 is a rational function presented in terms of the s-plane. The polynomial in the numerator has coefficients a₀, a₁, and a₂, and the roots of these represent the zeros of the transfer function. The polynomial in the denominator has coefficients, b₀, b₁, b₂, and b₃, and these represent the poles of the transfer function.

DFB 1304 contains several parallel signal paths, each of which is used to model a certain order of behavior of the corresponding input, such as first-order behavior, second-order behavior, etc. Each signal path is composed of a simple ideal non-linear power term followed by a linear transfer function. Power term 1312 is followed by a transfer function of one. Due to the existence of nonlinearities or nonidealities, the total circuit response can be seen as a sum of linear (nominal) response and non-linear distortions. Consequently, the behavior operator for this macromodel is an ideal summation unit that adds up different signal paths from the distortion generation block(s). The unit can also subtract by adding the inverse of a signal. Recall that the overall equivalent input source at the input port of the linearized circuit represents not only the original circuit input, but also equivalent sources for distortions. The distortion generation block(s) can be generated in a way such that the summed signal at the output of the behavior operator is matched to the overall equivalent input source. To achieve this, multiple circuit simulations and analyses are performed, and regression techniques can be used to find out the model coefficients in the distortion block(s). In this example power term 1314 is followed in a path by transfer function 1316, and power term 1318 is followed in a path by transfer function 1320.

FIG. 14 illustrates the compact or behavioral block type macromodel for the multiplicative case. Typical circuits that fall into this category include analog multipliers and mixers. The desired (nominal) circuit response in this category is not the linear response with respect to system inputs, but the second order multiplicative term of two inputs. As an example, the macromodel for a mixer is shown in FIG. 14. In FIG. 14, there are distortion function blocks, 1402, 1404, for both of an RF signal input, 1406, and local oscillator signal input 1408. These distortion function blocks take the same form as in additive circuits except that the sum over all of the parallel signal paths is the block output. Behavior operator 1410 is an ideal multiplication unit. The LTFB, 1412, is the transfer function from the port of the RF signal to the output, 1414. As discussed earlier, in the intermediate processing step, an equivalent input source is computed at the RF input port to account for the corresponding chord current source. Additionally, an equivalent source for the local oscillator signal is also found at the RF input port. Combining the RF input source with all the equivalent sources, an overall equivalent input source can be found. This overall equivalent input source accounts for the RF input, local oscillator signal, the desired second order term and other non-linear behaviors that appear to be non-linear distortions. The generation of both distortion function blocks should be carried out to match the signal at the output of the multiplication unit to the overall equivalent input source. Again, regression technique can be used in this regard.

FIG. 15 illustrates an alternative macromodel form for a multiplicative circuit such as the mixer discussed immediately above. In this case, RF input 1502 and local oscillator input 1504 go directly into the multiplicative behavior operator, 1506. Only one DFB, 1508 is provided. The LTFB and output are as illustrated in FIG. 14.

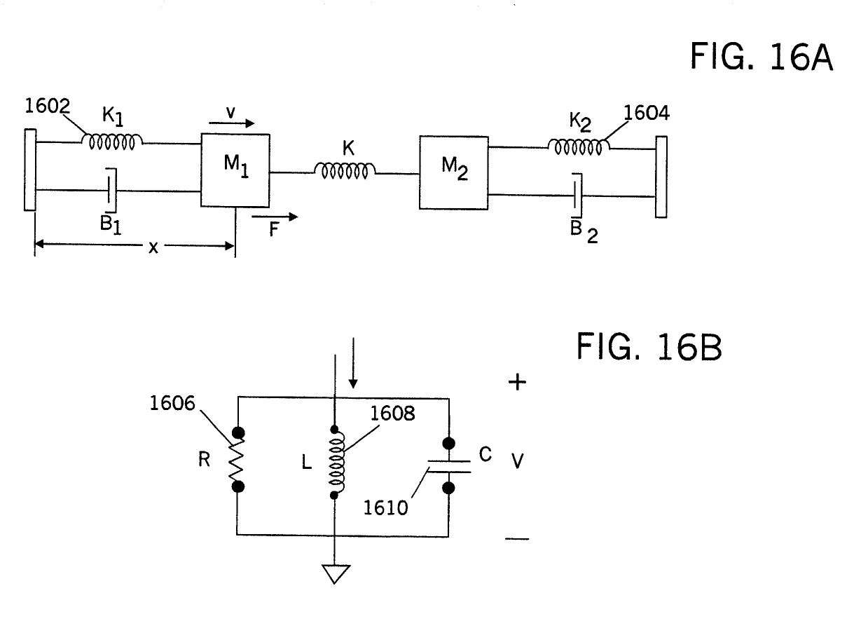

As previously mentioned a mechanical structure which can appear in a MEMS system can be analysed using the techniques of the invention. Such a structure and its corresponding circuit equivalent is illustrated in FIG. 16. In FIG. 16A, a force F which needs to be excerted on mass M₁ connected by spring K to mass M₂ in the direction shown such that M₁ maintains a velocity v can be expressed as:

F=M₁x+K₁x+B₁x

or

F=M₁v+K₁∫vdt+B₁v.

B₁ and B₂ are bumpers. Springs 1602 and 1604 have spring constants K₁ and K₂, respectively. For M₂, the same equations hold so that:

F=M₂x+K₂x+B₂x,

and

F=M₂v+K₂∫vdt+B₂v.

For the RLC network of FIG. 16B consisting of resistor 1606 of value R, inductor 1608 of value L, and capacitor 1610 of value C, we have:

$$I = CV + \frac{1}{L} \int V ⅆ t + \frac{1}{R} V .$$

where V is the voltage between the + and − terminals. Comparing the second equation for FIG. 16A with the equation for FIG. 16B, it can be seen that velocities, forces, masses, springs and bumpers in a mechenical system are analogus to voltages, currents, capacitors, inductors and resistors in an electrical network. With the presence of nonlinearities in the second MEMS equation, such as that B₁ is a non-linear function of velocity or displacement, one can model the non-linear bumper using the linear-centric approach of the invention, i.e., a linear bumper in parrallel with a non-linear force source. The resulting model would be analogous to the non-linear resistor model used for electronic circuits.

Improved efficiency is obtained through representing the circuit under simulation by a linearized model that can be modeled via many efficient linear system representations, such as in terms of poles and zeros. With the analog circuit examples shown, at each iteration step, only the current sources need to be evaluated, and then a constant linearized circuit is solved. This constant linearized circuit can be pre-factorized before the iteration loop starts and the same factorization is applied at each iteration step afterwards. Avoidance of constructing a new Jacobian matrix and solving a new linearized circuit at very iteration can lead to increased number of iterations for convergence but much less time per iteration is required compared to other methods. Alternatively, model order reduction can be used to represent the linear time-invariant portion of the circuit in terms of the dominant poles and zeros for further efficiency.

The invention can also capture analog system characteristics, such as non-linear distortion, with an efficient and compact model. All non-linear distortion attributes—on a per non-linear element basis—are captured via the time and/or frequency characteristics of the independent sources. This compact representation provides for the macromodeling of analog components, circuits and systems in terms of linearized models with corresponding time and/or frequency domain input signal disturbances. For example, the LNA of FIG. 3A can be represented by a macromodel that includes the poles and zeros of the small signal model, plus the frequency characteristics of independent sources corresponding to the individual transistors. This macromodel is only slightly more complex than a small signal model yet is able to capture analog circuit attributes such as non-linear distortion and phase noise during system-level or behavioral-level analysis. Macromodeling via such a linear-centric methodology that can still capture non-linear attributes of the circuit can provide system level simulation, analysis and modeling capabilities.

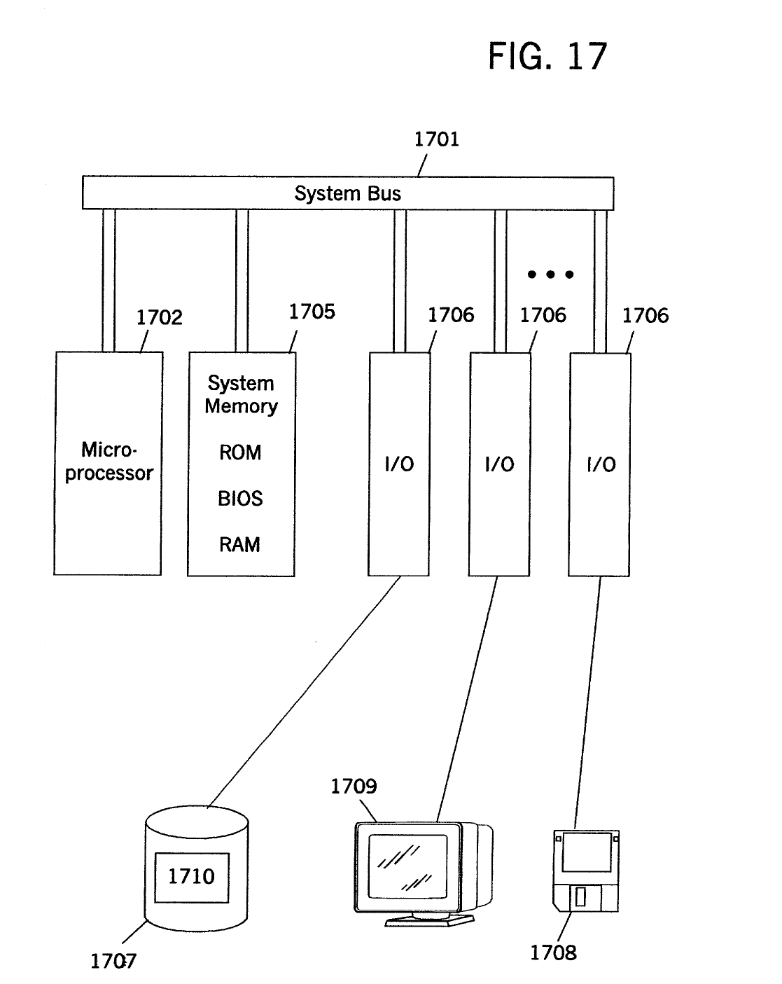

As previously discussed, in some embodiments, the invention in implemented through software operating on a programmable computer system or instruction execution system such as a personal computer or workstation, or other microprocessor-based platform. FIG. 17 illustrates further detail of a computer system that is implementing the invention in this way. System bus 1701 interconnects the major components. The system is controlled by microprocessor 1702, which serves as the central processing unit (CPU) for the system. System memory 1705 is typically divided into multiple types of memory or memory areas such as read-only memory (ROM), random-access memory (RAM) and others. The system memory may also contain a basic input/output system (BIOS). A plurality of general input/output (I/O) adapters or devices, 1706, are present. Only three are shown for clarity. These connect to various devices including a fixed disk drive, 1707, a diskette drive, 1708, and a display, 1709. Computer program instructions for implementing the functions of the invention, 1710, are stored on the fixed disk, 1707. When the system is operating, the instructions, 1710, are partially loaded into memory 1705 and executed by microprocessor 1702. It should be noted that the system of FIG. 17 is meant as an illustrative example only. Numerous types of general-purpose computer systems are available and can be used. Available systems include those that run operating systems such as Windows™ by Microsoft, various versions of Unix, and Apple's MAC™ OS.

Elements of the invention may be embodied in hardware and/or software as computer program code (including firmware, resident software, microcode, etc.). Furthermore, the invention may take the form of a computer program product on a computer-usable or computer-readable storage medium having computer-usable or computer-readable program instructions embodied in the medium for use by or in connection with an instruction execution system such as that shown in FIG. 17. Such a mediums is illustrated graphically in FIG. 17 to represent the diskette drive. A computer-usable or computer-readable medium may be any medium that can contain, store, communicate, or transport the program for use by or in connection with an instruction execution system. The computer-usable or computer-readable medium, for example, an electronic, magnetic, optical, electromagnetic, infrared, or semiconductor system. Note that the computer-usable or computer-readable medium could even be paper or another suitable medium upon which a program is printed. Computer program code can also be accessed or “downloaded” through a network such as the Internet.

It should be noted that the macromodel described herein can be implemented as computer coded descriptions of the varous elements encoded in a computer or machine readable memory in the form of a data structure. Again, this machine readable memory can take many forms such as the previously mentioned electronic, magnetic, optical, electromagnetic, infrared, or semiconductor system, apparatus, device, or propagation mediums, or even paper.

Specific embodiments of an invention are described herein. One of ordinary skill in the circuit analysis and computing arts will quickly recognize that the invention has other applications in other environments. In fact, many embodiments and implementations are possible. The following claims are in no way intended to limit the scope of the invention to the specific embodiments described above.

We claim:

1. A method of modeling a non-linear analog system comprising at least one linear element and at least one non-linear element, the method comprising:
linearizing the at least one non-linear element to create a linearized model of the at least one non-linear element; and
representing the non-linear analog system as a constant linear system with at least one independent source to capture the non-linear characteristics of the system.

2. The method of claim 1 wherein the linearizing of the at least one non-linear element is accomplished by replacing each of the at least one non-linear element with a linearized equivalent capturing a single large-signal operating point.

3. The method of claim 1 wherein the linearizing of the at least one non-linear element is accomplished by replacing each of the at least one non-linear element with a linearized equivalent capturing a weighted average over at least two large-signal operating points.

4. The method of claim 2 further comprising generating a response of the analog system by determining driving characteristics of the at least one independent source through solving non-linear harmonic balance equations using successive chord iterations.

5. The method of claim 3 further comprising generating a response of the analog system by determining driving characteristics of the at least one independent source through solving non-linear harmonic balance equations using successive chord iterations.

6. The method of claim 2 further comprising generating a macromodel of the analog system, wherein the macromodel further comprises:
a distortion function block;
a behavior operator connected to the distortion function block; and
a linear transfer function block.

7. The method of claim 3 further comprising generating a macromodel of the analog system, wherein the macromodel further comprises:
a distortion function block;
a behavior operator connected to the distortion function block; and
a linear transfer function block.

8. Apparatus for modeling a non-linear analog system comprising:
means for linearizing any non-linear element to create a linearized model of the at least one non-linear element; and
means for representing the non-linear analog system as a constant linear system with at least one independent source to capture non-linear characteristics of the system.

9. The apparatus of claim 8 further comprising means for generating a macromodel of the analog system.

10. A computer program product for enabling a computer system to model a non-linear analog system, the computer program product including a computer program comprising:
instructions for linearizing any non-linear element to create a linearized model of the at least one non-linear element; and
instructions for representing the non-linear analog system as a constant linear system with at least one independent source to capture non-linear characteristics of the system.

11. The computer program product of claim 10 wherein the instructions for linearizing replace each of the at least one non-linear elements with a linearized equivalent capturing a single large-signal operating point.

12. The computer program product of claim 10 wherein the instructions for linearizing replace each of the at least one non-linear elements with a linearized equivalent capturing a weighted average over at least two large-signal operating points.

13. The computer program product of claim 11 further comprising instructions for generating responses of the analog system by determining driving characteristics of the at least one independent source through solving non-linear harmonic balance equations using successive chord iterations.

14. The computer program product of claim 12 further comprising instructions for generating responses of the analog system by determining driving characteristics of the at least one independent source through solving non-linear harmonic balance equations using successive chord iterations.

15. The computer program product of claim 11 further comprising instructions for generating a macromodel of the analog system, wherein the macromodel further comprises:
a distortion function block;
a behavior operator connected to the distortion function block; and
a linear transfer function block.

16. The computer program product of claim 12 further comprising instructions for generating a macromodel of the analog system, wherein the macromodel further comprises:
a distortion function block;
a behavior operator connected to the distortion function block; and
a linear transfer function block.

17. An instruction execution system operable under the control of a computer program to model a non-linear analog system comprising at least one linear element and at least one non-linear element by performing the steps of:
linearizing the at least one non-linear element to create a linearized model of the at least one non-linear element; and
representing the non-linear analog system as a constant linear system with at least one independent source to capture non-linear characteristics of the system.

18. The instruction execution system of claim 17 wherein the linearizing of the at least one non-linear element is accomplished by replacing each of the at least one non-linear element with a linearized equivalent capturing a single large-signal operating point.

19. The instruction execution system of claim 17 wherein the linearizing of the at least one non-linear element is accomplished by replacing each of the at least one non-linear element with a linearized equivalent capturing a weighted average over at least two large-signal operating points.

20. The instruction execution system of claim 18 further operable to generate responses of the analog system by determining driving characteristics of the at least one independent source through solving non-linear harmonic balance equations using successive chord iterations.

21. The instruction execution system of claim 19 further operable to generate responses of the analog system by determining driving characteristics of the at least one independent source through solving non-linear harmonic balance equations using successive chord iterations.

22. The instruction execution system of claim 18 further operable to generate a macromodel of the analog system, wherein the macromodel further comprises:
a distortion function block;
a behavior operator connected to the distortion function block; and
a linear transfer function block.

23. The instruction execution system of claim 19 further operable to generate a macromodel of the analog system, wherein the macromodel further comprises:
a distortion function block;
a behavior operator connected to the distortion function block; and
a linear transfer function block.

24. A reduced representation of an analog system, the reduced representation comprising:
a linear subsystem further comprising linear elements of the analog system and a linearized representation for at least one, non-linear element of the analog system; and
at least one, independent source corresponding to the at least one linearized representation, the at least one, independent source having driving characteristics determined by solving non-linear harmonic balance equations using successive chord iterations.

25. The reduced representation of claim 24 wherein the linearized representation of the at least one non-linear element is created by replacing the at least one non-linear element with a linearized equivalent capturing a single large-signal operating point.

26. The reduced representation of claim 24 wherein the linearized representation of the at least one non-linear element is created by replacing the at least one non-linear element with a linearized equivalent capturing a weighted average over at least two large-signal operating points.

27. A machine readable memory encoded with a data structure for defining a reduced representation of an analog system, the data structure comprising:
a linear subsystem description wherein the linear subsystem comprises linear elements of the analog system and at least one linearized portion of at least one, non-linear element of the analog system, and
a nonlinear source description corresponding to the at least one linearized portion, the non-linear source having independent driving characteristics determined by solving non-linear harmonic balance equations using successive chord iterations.

28. The memory of claim 27 wherein the linearized portion of the at least one non-linear element are created by replacing the at least one non-linear element with a linearized equivalent capturing a single large-signal operating point.

29. The memory of claim 27 wherein the linearized portion of the at least one non-linear element are created by replacing the at least one non-linear element with a linearized equivalent capturing a weighted average over at least two large-signal operating points.

30. A macromodel of an analog system, the macromodel comprising:
an output and at least one input;
a linear transfer function block disposed at the output of the macromodel;
at least one distortion function block for modeling non-linear behavior based on independent source functions that are derived through simulation, the at least one distortion function block disposed between the at least one input and the linear transfer function block; and
a behavior operator disposed between the at least one input and the linear transfer function block.

31. The macromodel of claim 30 wherein the behavior operator is a summation unit.

32. The macromodel of claim 30 wherein the behavior operator is a multiplication unit.

33. The macromodel of claim 32 wherein the behavior operator is further disposed between the at least one distortion function block and the linear transfer function block.

34. The macromodel of claim 32 wherein the behavior operator is further disposed between the at least one input and the at least one distortion function block.

35. A machine readable memory encoded with a data structure for defining a macromodel for an analog system, the data structure comprising:
a linear transfer function block description disposed at the output of the macromodel;
a distortion function block description for enabling the modeling of non-linear behavior based on chord currents derived through simulation; and
a behavior operator description.

36. The memory of claim 35 wherein the behavior operator is a summation unit.

37. The memory of claim 35 wherein the behavior operator is a multiplication unit.

38. A method of modeling a non-linear analog system comprising at least one linear element and at least one non-linear element, the method comprising:
linearizing the at least one non-linear element to create a linearized model of the at least one non-linear element; and
representing the non-linear analog system as a constant linear system with at least one independent source to capture the non-linear characteristics of the system, wherein each of the at least one independent sources is a frequency domain source, a time domain source, or a combination of frequency domain and time domain sources.

39. The method of claim 38 wherein the linearizing of the at least one non-linear element is accomplished by replacing each of the at least one non-linear element with a linearized equivalent capturing a single large-signal operating point.

40. The method of claim 38 wherein the linearizing of the at least one non-linear element is accomplished by replacing each of the at least one non-linear element with a linearized equivalent capturing a weighted average over at least two large-signal operating points.

41. The method of claim 39 further comprising generating a response of the analog system by determining driving characteristics of the at least one independent source through solving non-linear harmonic balance equations using successive chord iterations.

42. The method of claim 40 further comprising generating a response of the analog system by determining driving characteristics of the at least one independent source through solving non-linear harmonic balance equations using successive chord iterations.

43. The method of claim 39 further comprising generating a macromodel of the analog system, wherein the macromodel further comprises:
a distortion function block;
a behavior operator connected to the distortion function block; and
a linear transfer function block.

44. The method of claim 40 further comprising generating a macromodel of the analog system, wherein the macromodel further comprises:
a distortion function block;
a behavior operator connected to the distortion function block; and
a linear transfer function block.

45. An instruction execution system operable under the control of a computer program to model a non-linear analog system comprising at least one linear element and at least one non-linear element by performing the steps of:
linearizing the at least one non-linear element to create a linearized model of the at least one non-linear element; and
representing the non-linear analog system as a constant linear system with at least one independent source to capture non-linear characteristics of the system, wherein each of the at least one independent sources is a frequency domain source, a time domain source, or a combination of frequency domain and time domain sources.

46. The instruction execution system of claim 45 wherein the linearizing of the at least one non-linear element is accomplished by replacing each of the at least one non-linear element with a linearized equivalent capturing a single large-signal operating point.

47. The instruction execution system of claim 45 wherein the linearizing of the at least one non-linear element is accomplished by replacing each of the at least one non-linear element with a linearized equivalent capturing a weighted average over at least two large-signal operating points.

48. The instruction execution system of claim 46 further operable to generate responses of the analog system by determining driving characteristics of the at least one independent source through solving non-linear harmonic balance equations using successive chord iterations.

49. The instruction execution system of claim 47 further operable to generate responses of the analog system by determining driving characteristics of the at least one independent source through solving non-linear harmonic balance equations using successive chord iterations.

50. The instruction execution system of claim 46 further operable to generate a macromodel of the analog system, wherein the macromodel further comprises:
a distortion function block;
a behavior operator connected to the distortion function block; and
a linear transfer function block.

51. The instruction execution system of claim 47 further operable to generate a macromodel of the analog system, wherein the macromodel further comprises:
a distortion function block;
a behavior operator connected to the distortion function block; and
a linear transfer function block.

52. A macromodel of an analog system, the macromodel comprising:
an output and at least one input;
a linear transfer function block disposed at the output of the macromodel;
at least one distortion function block for modeling non-linear behavior based on independent source functions that are derived through simulation, wherein each independent source function is a time domain function or a frequency domain function, the at least one distortion function block disposed between the at least one input and the linear transfer function block; and
a behavior operator disposed between the at least one input and the linear transfer function block.

53. The macromodel of claim 52 wherein the behavior operator is a summation unit.

54. The macromodel of claim 52 wherein the behavior operator is a multiplication unit.

55. The macromodel of claim 54 wherein the behavior operator is further disposed between the at least one distortion function block and the linear transfer function block.

56. The macromodel of claim 54 wherein the behavior operator is further disposed between the at least one input and the at least one distortion function block.
